(19) United States
(12) Patent Application Publication
(10) Pub. No.: US 2017/0217340 A1
(43) Pub. Date: Aug. 3, 2017

(54) CAR SEAT SUPPORTING APPARATUS

(71) Applicants: Igor Estraykh, Woodland Hills, CA (US); Shelby Estraykh, Woodland Hills, CA (US)

(72) Inventors: Igor Estraykh, Woodland Hills, CA (US); Shelby Estraykh, Woodland Hills, CA (US)

(21) Appl. No.: 15/012,485

(22) Filed: Feb. 1, 2016

(51) Int. Cl. B60N 2/28; A47D 15/00; A47D 1/10

(52) U.S. Cl. CPC B60N 2/2842; A47D 1/10; A47D 15/00

(57) ABSTRACT

A car seat supporting apparatus is described. The car seat supporting apparatus can include a pair of rigid members configured to engage with a support structure. The car seat supporting apparatus can also include a pair of flexible members disposed between the pair of rigid members. The pair of flexible members can be configured to support an infant car seat when the car seat supporting apparatus is deployed in the support structure.

### BACKGROUND

Modern infant car seat systems typically include a base and an infant car seat. The base is secured in a vehicle using a seatbelt or certain specialized straps. The base can include a quick securing mechanism by which the infant car seat can be quickly and securely attached to the base. During loading of the infant car seat, this quick securing mechanism securely couples with a corresponding structure of the infant car seat (e.g., a pair of grooves that engage with the quick securing mechanism). During unloading of the infant car seat, the quick securing mechanism is released and a user is free to remove the infant car seat, with the base remaining in the vehicle. The user is now free to tote the infant with the infant remaining in the infant car seat. While this presents a convenient option for users on the go, the size and shape of infant car seats can introduce challenges to conducting certain tasks. For example, use of an infant car seat in connection with a shopping cart at a grocery store can be burdensome. A first option for using the infant car seat can include placing the infant car seat within a cart portion of the shopping cart. This may be undesirable, however, as the infant car seat may occupy most, if not all, of the space in the cart portion, leaving little to no space for groceries. A second option for using the infant car seat can include hanging the infant car seat to a front or rear railing of the cart portion. Typically, this not only results in the infant being held at an uncomfortable angle, but also can result in damage to the corresponding structure that can cause the quick securing mechanism of the base to not properly retain the infant car seat.

### SUMMARY

Examples of the present disclosure are directed to car seat supporting apparatuses. In some examples, a car seat supporting apparatus can include a first, elongate rigid member and a second, elongate rigid member. Each of the elongate rigid members can include an elongate channel along a length of the elongate, rigid member defined by a U-shaped cross section of the respective elongate, rigid member. Each elongate channel can be configured to extend along and receive an upper railing of a shopping cart. Each of the elongate rigid members can also include a securing device mounted to the elongate, rigid member and configured to secure the elongate, rigid member to the upper railing of the shopping cart when the elongate channel of the elongate, rigid member receives the upper railing. The car seat supporting apparatus can also include a pair of flexible straps connecting opposing side walls of the first, elongate rigid member and the second, elongate rigid member at respective front connection locations and respective rear connection locations on the opposing sidewalls of the first, elongate rigid member and the second, elongate rigid member. Each flexible strap of the pair of flexible straps can include a tension mechanism configured to adjust a length of the respective flexible strap. The elongate, rigid members and the pair of flexible straps are connected to each other and arranged such that when the first and second elongate, rigid members are installed on opposite upper railings of a shopping cart and the securing devices secure the elongate rigid members to the upper railings, the tension mechanisms of the flexible straps are adjusted so that the flexible straps are tensioned and extend substantially parallel, and when tensioned, the flexible straps are spaced to engage with and support an infant car seat on opposite, underside edges of the infant car seat.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

The disclosure will be readily understood by the following detailed description in conjunction with the accompanying drawings, in which:

FIG. 1 shows an isometric view of a car seat supporting system including a car seat supporting apparatus deployed in a support structure and supporting an infant car seat, in accordance with at least one example;

FIG. 2 shows a top view of the car seat supporting apparatus from FIG. 1, in accordance with at least one example;

FIG. 3 shows a side view of the car seat supporting apparatus from FIG. 1, in accordance with at least one example;

FIG. 4 shows a detailed view of an aspect of the car seat supporting apparatus from FIG. 1, in accordance with at least one example;

FIG. 5 shows an isometric view of a car seat supporting system including the car seat supporting apparatus from FIG. 1 deployed in a support structure, in accordance with at least one example;

FIG. 6A shows a side view of an aspect of the car seat supporting apparatus from FIG. 1 in connection with an infant car seat, in accordance with at least one example; and

FIG. 6B shows a side view of an aspect of the car seat supporting apparatus from FIG. 1 in connection with an infant car seat, in accordance with at least one example, in accordance with at least one example.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments of present disclosure are directed to car seat supporting apparatuses. In particular, embodiments are directed to car seat supporting apparatuses adapted to support an infant car seat within a support structure such as a cart portion of a shopping cart. The car seat supporting apparatuses described herein are configured to support the infant car seats well above the bottom of the shopping cart. This can free up space for groceries that would otherwise be occupied by the infant car seat resting on the bottom of the cart portion of the shopping cart. In addition, use of the car seat supporting apparatuses described herein can reduce the potential for damage to quick release structures that are present on modern day infant car seats. The car seat supporting apparatuses described herein have been designed to support any suitable infant car seat in any suitable support structure (e.g., shopping carts). In this manner, a single car seat supporting apparatus works to support different styles and brands of infant car seats in support structures having various designs (e.g., railing thickness, railing-to-railing widths, and any other suitable design characteristic).

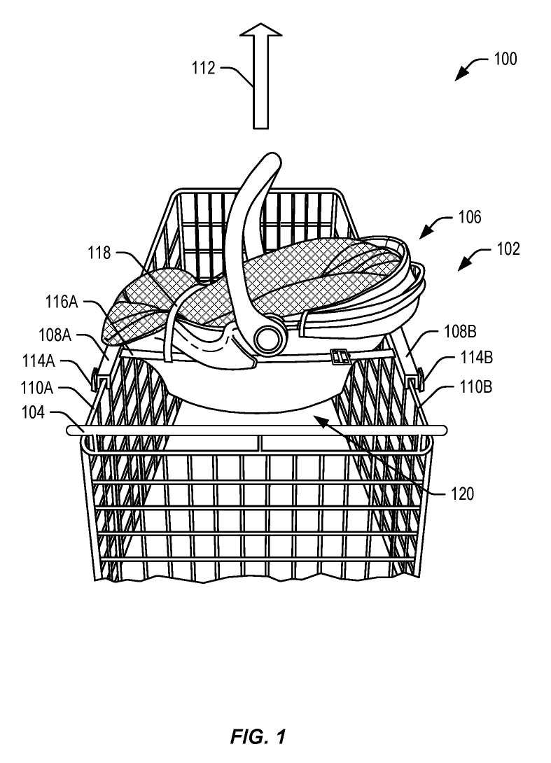

Turning now to the figures, FIG. 1 illustrates a car seat supporting system 100 including a car seat supporting apparatus 102 deployed in a support structure 104 and supporting an infant car seat 106, in accordance with at least one example. The car seat supporting apparatus 102 can be configured to be deployed in any suitable support structure 104 such as, for example, shopping carts, rolling utility carts, flatbed carts that include two or more vertical structures, or any other suitable support structure. In a particular example, the car seat supporting apparatus 102 may be provided. A user (e.g., a parent or caretaker of a child) may desire that the child remain in her infant car seat (e.g., the infant car seat 106) while the user shops at a grocery store. This may be because the child is too small to sit upright in a shopping cart (an example of the support structure 104) or is sleeping. To accommodate the user's desire, the user may deploy the car seat supporting apparatus 102 in the shopping cart (e.g., the support structure 104) at the grocery store. Deploying the car seat supporting apparatus 102 can include placing each of two rigid members 108A, 108B on opposing upper railings 110A, 110B (e.g., on the left and right railings) of the support structure 104 when the user is aligned with a forward direction of travel 112 of the support structure 104. The two rigid members 108 can be securely attached to the upper railing 110 using a pair of securing devices 114A, 114B. In some examples, more than one securing device 114 is attached to each of the rigid members 108. For example, each of the rigid members 108 can include two securing devices 114 at opposite ends of the respective rigid member 108.

The car seat supporting apparatus 102 can also include two flexible members 116A, 116B (located behind the infant car seat 106) extending between the two rigid members 108. Continuing with the example above, the user can adjust the flexible members 116 to correspond to the width between the upper railings 110A, 110B to which the rigid members 108A, 108B are attached. Adjusting the flexible members 116 can include adjusting the tension in the flexible members 116 using tension mechanisms as described herein. The user may then place the infant car seat 106 such that it rests on the each of the flexible members 116A, 116B and is supported by each of the flexible members 116A, 116B. In some examples, at least a portion of the infant car seat 106 is supported by one or both of the rigid members 108A, 108B.

The car seat supporting apparatus 102 can also include a flexible belt strap 118. The flexible belt strap 118 can extend between the two flexible members 116. Continuing with the example above, during use, the user can bring the flexible belt strap 118 over the top of the infant car seat 106. In some examples, the flexible belt strap 118 can include a fastening device that connects the flexible belt strap 118 and can be used to adjust tension in the flexible strap 118. The flexible belt strap 118 can function to securely hold the infant car seat 106 to the car seat supporting apparatus 102. Because the car seat supporting apparatus 102 holds the infant car seat 106 such that a bottom surface of the infant car seat 106 lies slightly below a top surface of the upper railing 110, a large proportion of the cart portion 120 of the support structure 104 remains available for receiving grocery items. The user can also easily view the child and respond to the child's needs as the user pushes the support structure 104.

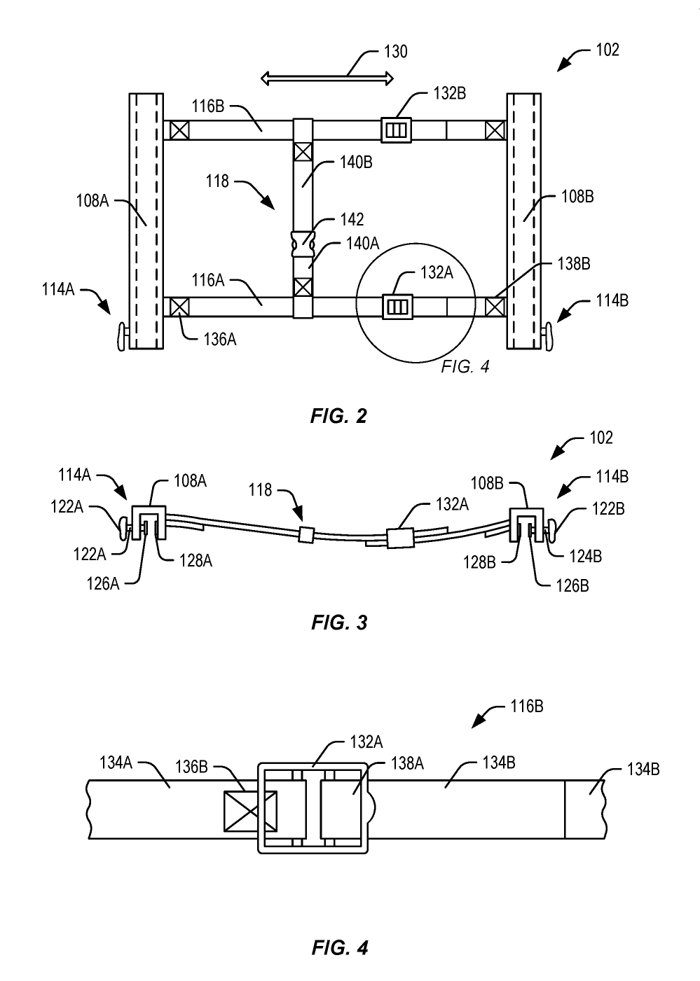

FIGS. 2-4 illustrate aspects of the car seat supporting apparatus 102, in accordance with at least one example. As introduced herein, the car seat supporting apparatus 102 can include the rigid members 108, the flexible members 116, and the flexible belt strap 118. The rigid members 108 can have an elongate shape with a U-shaped cross sections within the elongate shape. For example, the shape of the rigid members 108 can correspond to that of a U-channel stock, having a pair of flanges separated by a web that extends between the pair of flanges and connects the pair of flanges at opposite edges of the pair of flanges. In some examples, the pair of flanges can be dimensioned to accept any suitable support structure 104. For example, the pair of flanges can be about two inches (2″) wide. The rigid members 108 can be formed of any suitable rigid material including, for example, steel, aluminum, plastic, layered composite, formed rubber, and/or any other suitable material having characteristics of rigidity. The channels of the rigid members 108 (e.g., the portions that correspond to the inside of U-shaped cross sections) can be configured to receive components of the support structure 104 (e.g., the upper railing 110) having various widths. For example, when the car seat supporting apparatus 102 is deployed in a shopping cart (e.g., a type of the support structure 104) the rigid members 108 can be placed over opposing sides of a top railing of a cart portion of the shopping cart. In this manner, the top railing lies within the channels of the rigid members 108. In some examples, the rigid members 108 also include padding attached to outward-facing surfaces of the webs. Certain infant car seats, when supported by the car seat supporting apparatus 102, may rest on the outward-facing surfaces of the webs. The padding may be desirable to decrease wear on the webs and on opposing surfaces of the infant car seats. The padding can be any suitable padding including, for example, foam, textiles, and/or any other suitable material.

The securing devices 114 are configured to securely hold components of the support structure 104 (e.g., the upper railing 110) within the channels of the rigid members 108. To this end, as illustrated in FIG. 3, each securing device 114 can include a handle 122 attached to a contact surface 126 via a rod 124. In some examples, each securing device 114 can also include an opposing contact surface 128. The rod 124 can be threaded or otherwise include functionality to move the contact surface 126 towards the opposing contact surface 128, with the component of the support structure 104 being disposed between the contact surface 126 and the opposing contact surface 128. For example, a user may engage the handle 122 and rotate the handle which can cause the contact surface 126 to move towards the opposing contact surface 128. The contact surface 126 and the opposing contact surface 128 can include any suitable combination of rigid and flexible materials, at least some of which can have high coefficients of friction to improve engagement between the securing devices 114 and the top railing. For example, the contact surface 126 can include a metal tab with a piece of rubber attached thereto. The opposing contact surface 128 can also include a piece of rubber attached to an interior surface of the rigid member 108. In some examples, in addition to or in the place of the handle 122, the rod 124, and the contact surface 126, each of the securing devices 114 can include a ratchet, a cam-over device including a threaded bolt, a spring-loaded locking clamp, or any other suitable device for clamping the component of the support structure 104 within the U portions of the rigid members 108. In some examples, the securing devices 114 can include the rigid members 108 configured to snugly receive the upper railing within the channels. For example, interior widths of the channels can be slightly larger than exterior widths of the upper railing such that the upper railing fits within the channels of the rigid members 108 with a very small amount of variance. This may result in a simplified version of the rigid members 108 as compared to one that uses the securing devices 114. In some examples, the channels can include an elastic material and/or a deflectable material disposed therein that can expand and contract to retain the upper railing within the channels. In some examples, the elastic and/or deflectable material may also provide a high amount of friction between the upper railing and the rigid members 118.

The flexible members 116 can be attached to opposing side walls of the rigid members 108 at a pair of front mounting locations and a pair of rear mounting locations. The front and rear mounting locations can be selected such that a spacing between the flexible members is adequate for the flexible members 116 to engage with and support the infant car seat 106. In some examples, the flexible members 116 are attached to the rigid members 108 such that the flexible member 116A is about parallel to the flexible member 116B. The flexible members 116 can be configured to expand and contract in the directions indicated by arrow 130 in order to accommodate support structures having varying widths. In some examples, the flexible members 116 can be formed from flexible material in the shape of straps having rectangular profiles or cords having circular profiles. Examples of flexible material include: polyester web, nylon web, polypropylene web, textiles, shock cord, and any other flexible material. As described herein, the flexible members 116 can have elastic properties.

Adjustability of the pair of flexible members 116 can be achieved using one or more tension devices 132A, 132B. The tension devices 132 can be disposed at any location on the flexible members 116 (e.g., in the middle or near the ends). The tension devices 132 can be any suitable device capable of maintaining tension in the flexible members 116 when the car seat supporting apparatus 102 supports the infant car seat 106. Examples of tension devices 132 include strap adjusters, buckles, barrel lock tensioners, any other suitable device.

In some examples, each flexible member 116 can be formed from two pieces of flexible material. For example, with reference to the flexible member 116A in FIGS. 2 and 4, a first piece of flexible material 134A can be attached to a side wall of the rigid member 108A at a first end 136A and attached to the tension device 132A at a second end 136B. A second piece of flexible material 134B can be attached to a side wall of the rigid member 108B at a first end 138B and threaded through the tension device 132A at a second end 138A. In this manner, the tension device 132A can be used to connect the two pieces of flexible material 134A, 134B. The tension device 132A can be used to adjust the length of the first piece of flexible material 134A, the length of the second piece of flexible material 134B, and/or the length of both pieces of flexible material 134A, 134B and thereby adjust the tension in the flexible member 116A.

In other examples, each flexible member 116 can be formed from a single piece of flexible material with each tension device 132 configured to tighten the single piece of flexible material. For example, with reference to the flexible member 116A, a first end of the single piece of flexible material can be threaded through a side wall of the rigid member 108A and attached to itself (e.g., sewn). A second end can also be threaded through a side wall of the rigid member 108B and into the tension device 132A. The tension device 132A can also be attached to the single piece of flexible material at a location between the first end and the second end. In this manner, the tension device 132A can be used to adjust the length of the single piece of flexible material and thereby adjust the tension in the single piece of flexible material that makes up the flexible member 116A.

In some examples, the flexible members 116 can be rigid devices that are capable of length-wise adjustment. For example, each flexible member 116 can be a telescoping member and each tension device 132 can be a cam-locking mechanism that secures the telescoping member at any suitable variable length. In some examples, the flexible members 116 can have elastic properties. For example, when the flexible members 116 have elastic properties, the tension devices 132 may not be needed because the lengths of the flexible members 116 can be selected such the flexible members 116 have suitable tensions across a range of mounting widths of the rigid members 108. The range of mounting widths can correspond to widths of a set of shopping carts that are most common.

The flexible belt strap 118 can be formed from a flexible material such as polyester web, nylon web, polypropylene web, textiles, shockcord, or any other flexible material. The flexible belt strap 118 can be slidably coupled to each of the flexible members 116A, 116B at each end of the flexible belt strap 118. In this manner, the flexible belt strap 118 can be free to slide relative to the rigid members 108 as the flexible members 116 are lengthened and shortened. In other examples, the flexible belt strap 118 is sewn or otherwise fixedly attached (e.g., sewn) to each of the flexible members 116A, 116B. Like the flexible members 116, the flexible belt strap 118 can include a tension device to adjust the tension in flexible belt strap 118 (e.g., to cinch the flexible belt strap 118 to retain the infant car seat 106). In some examples, the flexible belt strap 118 can be formed from two segments 140A, 140B. A first end of each segment 140 can be coupled, fixedly or slidably, to each of the flexible members 116A, 116B. In addition, a second end of each segment 140 can be attached to a fastening device 142. The fastening device 142 may be configured to releasably couple the first segment 140A and the second segment 140B. In some examples, the fastening device 142 also functions to adjust the tension in the first segment 140A, the second segment 140B, or both segments 140A, 140B. The flexible belt strap 118 can function as a flexible belt to restrain the infant car seat 106.

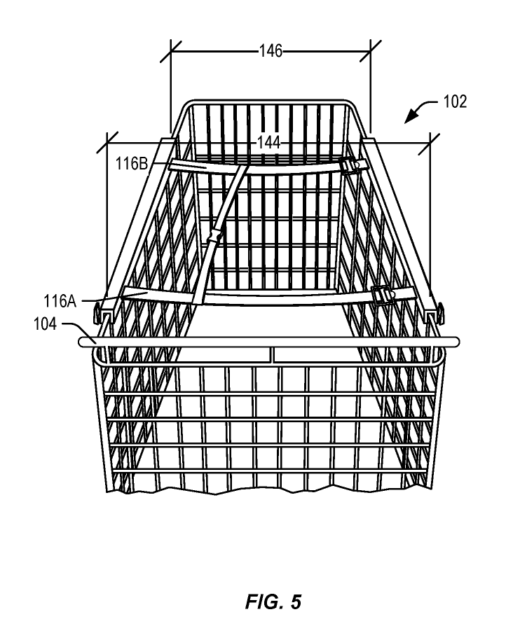

FIG. 5 illustrates the car seat supporting apparatus 102 in a deployed state in the support structure 104 prior to the infant car seat 106 being loaded, in accordance with at least one example. The support structure 104 has an increasingly narrowing shape from rear to front. Thus, a rear width 144 may be greater than a front width 146. Unlike supporting apparatuses that have a fixed width or are formed from a single piece of material, the car seat supporting apparatus 102 can be deployed in the support structure 104 having the various widths 144, 146 and function suitably. This may be because each of the flexible members 116A, 116B is independently adjustable. Thus, the flexible member 116A can be adjusted to correspond to the rear width 144 and the flexible member 116B can be adjusted to correspond to the front width 146.

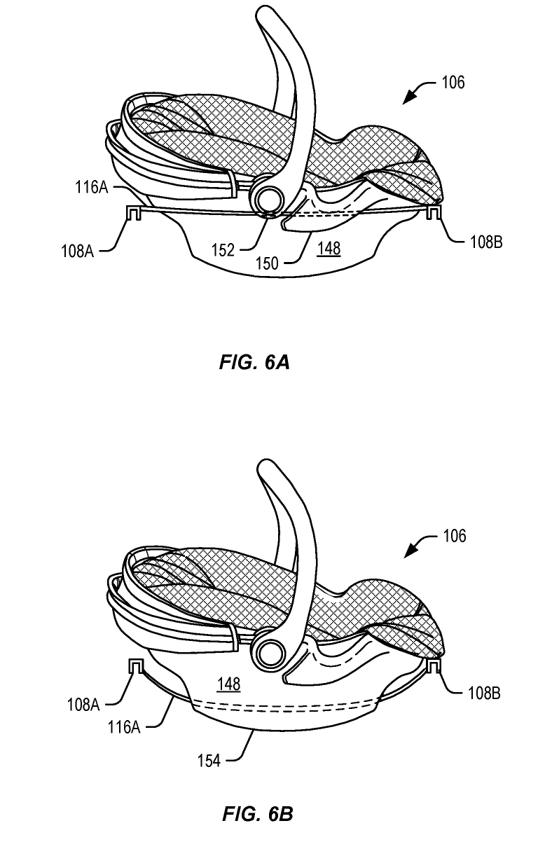

FIGS. 6A and 6B illustrate the infant car seat 106, the pair of rigid members 108, and the flexible member 116A, in accordance with at least two example contact locations for the flexible members 116. The pair of rigid members 108 can be configured to contact and engage with portions of the infant car seat 106. In some examples, the infant car seat 106 rests on at least one of the pair of rigid members 108 and the pair of flexible members 116.

The flexible members 116 can be configured to contact the infant car seat 106 at any suitable locations along a bottom surface and/or side surface of the infant car seat. For example, as illustrated in FIG. 6A, the flexible member 116A can be routed between a side surface 148 and a ridge 150 and/or a handle mounting structure 152 of the infant car seat 106. In this manner, the flexible member 116A can contact and engage with the infant car seat 106 at the side surface 148, the ridge 150, and the handle mounting structure 152. In some examples, the flexible member 116A contacts and engages with the infant car seat 106 at other locations in addition to, or in the place of, the side surface 148, the ridge 150, and the handle mounting structure 152.

In some examples, as illustrated in FIG. 6B, the flexible member 116A can be routed to engage with a bottom surface 154 of the infant car seat 106. In this manner, the flexible member 116A can contact and engage with the infant car seat 106 at the bottom surface 154. In some examples, the bottom surface 154 can include one or more grooves into which the flexible members 116 can be routed. In this manner, the flexible members 116 can restrain the infant car seat 106 from moving side-to-side. In some examples, the flexible members 116 contact the bottom surface 154 and engage with underside edges of the bottom surface 154 without also being routed through any grooves or other similar structure. The grooves or other structures disposed along the bottom surface 154 can correspond to a quick-securing mechanism of the infant car seat 106. In some examples, the routing of the flexible member 116A can be considered to engage with a portion of the bottom surface 154 of the infant car seat 106 that is disposed on an underside of the ridge 150 and an underside of the handle mounting structure 152.

Spatially relative terms, such as “below,” “above,” “lower,” “upper,” and the like may be used above to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

The above description of embodiments of the disclosure has been presented for the purposes of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the claimed subject matter in various embodiments and with various modifications as are suited to the particular use contemplated. Thus, it will be appreciated that the disclosure is intended to cover all modifications and equivalents within the scope of the following claims.

What is claimed is:

1. An infant car seat supporting apparatus adapted to support an infant car seat, the infant car seat supporting apparatus comprising:
a first, elongate rigid member;
a second, elongate rigid member, each of the first, elongate rigid member and the second, elongate rigid member comprising:
an elongate channel along a length of the elongate rigid member defined by a U-shaped cross section of the respective elongate rigid member, the elongate channel configured to extend along and receive an upper railing of a shopping cart; and
a securing device mounted to the elongate rigid member and configured to secure the elongate rigid member to the upper railing of the shopping cart when the elongate channel of the elongate rigid member receives the upper railing; and
a pair of flexible straps connecting opposing side walls of the first, elongate rigid member and the second, elongate rigid member at respective front connection locations and respective rear connection locations on the opposing sidewalls of the first, elongate rigid member and the second, elongate rigid member, each flexible strap of the pair of flexible straps comprising a tension mechanism configured to adjust a length of the respective flexible strap; and
wherein, the elongate rigid members and the pair of flexible straps are connected to each other and arranged such that when the first and second, elongate rigid members are installed on opposite upper railings of the shopping cart and the securing devices secure the elongate rigid members to the opposite upper railings, the tension mechanisms of the flexible straps are adjusted so that the flexible straps are tensioned and extend substantially parallel, and when tensioned, the flexible straps are spaced to engage with and support the infant car seat on opposite, underside edges of the infant car seat.

2. The infant car seat supporting apparatus of claim 1, wherein the securing devices secure the elongate rigid members to the upper railings such that the elongate rigid members are restrained from rotating towards each other when the pair of flexible straps are tensioned and when the infant car seat is supported by the pair of flexible straps.

3. The infant car seat supporting apparatus of claim 1, wherein the length of each of the flexible straps is selected such that, when the first and second, elongate rigid members are installed on the opposite upper railings, the pair of flexible straps remain connected to the opposing side walls and can be tensioned using the respective tension mechanisms.

4. The infant car seat supporting apparatus of claim 1, wherein each of the securing devices comprises:
a handle;
a rod connected to the handle at a first end of the rod; and
a contact surface disposed at a second end of the rod, the respective securing device configured to move the contact surface via the rod in to contact with the upper railing of the shopping cart and releasably secure respective elongate rigid members of the infant car seat supporting apparatus to the upper railing of the shopping cart.

5. The infant car seat supporting apparatus of claim 1, wherein each of the securing devices comprises one or more of a threaded securing device, a ratchet securing device, a cam-over securing device, or a spring-loaded locking securing device.

6. The infant car seat supporting apparatus of claim 1, further comprising a flexible belt strap extending between and connecting the pair of flexible straps, the flexible belt strap comprising:
a first segment;
a second segment; and
a fastening device capable of releasably coupling the first segment and the second segment.

7. The infant car seat supporting apparatus of claim 6, wherein the pair of flexible straps comprises a first flexible strap and a second flexible strap, and wherein the first segment of the flexible belt strap is slidably coupled to the first flexible strap, and the second segment of the flexible belt strap is slidably coupled to the second flexible strap.

8. The infant car seat supporting apparatus of claim 1, wherein, the elongate rigid members and the pair of flexible straps are connected to each other and arranged such that when the first and second, elongate rigid members are installed on the opposite upper railings of the shopping cart and the securing devices secure the elongate rigid members to the upper railings, at least one of the elongate rigid members engages with and supports the infant car seat on a front or rear underside edge of the infant car seat.

9. A method of using an infant car seat support apparatus, the method comprising:
installing a first, elongate rigid member along an upper railing of a shopping cart at a first location such that the upper railing is received within a first elongate channel of the first, elongate rigid member, the first elongate channel disposed along a length of the first, elongate rigid member and defined by a U-shaped cross section of the first, elongate rigid member;
securing, using a first securing device mounted to the first, elongate rigid member, the upper railing within the first elongate channel of the first, elongate rigid member;
installing a second, elongate rigid member along the upper railing of the shopping cart at a second location such that the upper railing is received within a second elongate channel of the second, elongate rigid member, the second elongate channel disposed along a length of the second, elongate rigid member and defined by a U-shaped cross section of the second, elongate rigid member;
securing, using a second securing device mounted to the second, elongate rigid member, the upper railing within the second elongate channel of the second, elongate rigid member;
tensioning a first flexible strap using a first tension mechanism configured to adjust a length of the first flexible strap, the first flexible strap connecting opposing side walls of the first, elongate rigid member and the second, elongate rigid member at respective front connection locations on the opposing sidewalls of the first, elongate rigid member and the second, elongate rigid member;
tensioning a second flexible strap using a second tension mechanism configured to adjust a length of the second flexible strap, the second flexible strap connecting the opposing side walls of the first, elongate rigid member and the second, elongate rigid member at respective rear connection locations on the opposing sidewalls of the first, elongate rigid member and the second, elongate rigid member, wherein, the first and second elongate, rigid members and the first and second flexible straps are connected to each other and arranged such that when the first and second elongate, rigid members are installed on the upper railing of the shopping cart and the first and second securing devices secure the first and second, elongate rigid members to the upper railing, the first and second tension mechanisms are adjusted so that the first and second flexible straps are tensioned and extend substantially parallel, and when tensioned, the flexible straps are spaced to engage with and support an infant car seat on opposite, underside edges of the infant car seat; and
installing the infant car seat in the infant car seat supporting apparatus such that the first and second flexible straps engage with and support the infant car seat on the opposite, underside edges of the infant car seat.

10. The method of claim 9, wherein securing the second securing device mounted comprises adjusting the second securing device at least until the second securing device contacts the upper railing within the second elongate channel.

11. The method of claim 9, wherein the first and second securing devices secure the first and second, elongate rigid members to the upper railing such that the first and second, elongate rigid members are restrained from rotating towards each other after the first and second flexible straps are tensioned and after the infant car seat has been installed in the infant car seat supporting apparatus.

12. The method of claim 9, wherein the lengths of the first and second flexible straps are selected such when the first and second elongate, rigid members are installed on the upper railing, the first and second flexible straps remain connected to the opposing side walls and can be tensioned using the first and second tension mechanisms.

13. The method of claim 9, wherein each of the first and second securing devices comprise:
a handle;
a rod connected to the handle at a first end of the rod; and
a contact surface disposed at a second end of the rod, the respective securing device configured to move the contact surface via the rod in to contact with the upper railing of the shopping cart and releasably secure respective elongate rigid members of the infant car seat supporting apparatus to the upper railing of the shopping cart.

14. The method of claim 9, wherein each of the first and second securing devices comprise one or more of a threaded securing device, a ratchet securing device, a cam-over securing device, or a spring-loaded locking securing device.

15. The method of claim 9, further comprising, after installing the infant car seat, securing, using a flexible belt strap, the infant car seat to the infant car seat apparatus.

16. The method of claim 15, wherein the flexible belt strap extends between and connects the first and second flexible straps, the flexible belt strap comprising:
a first segment;
a second segment; and
a fastening device capable of releasably coupling the first segment and the second segment.

17. The method of claim 17, wherein the first segment of the flexible belt strap is slidably coupled to the first flexible strap, and the second segment of the flexible belt strap is slidably coupled to the second flexible strap.

18. The method of claim 17, wherein securing, using the flexible belt strap, the infant car seat comprises connecting, using the fastening device, the first segment of the flexible belt strap to the second segment of the flexible belt strap.

19. An infant car seat supporting apparatus adapted to support an infant car seat, the infant car seat supporting apparatus comprising:
a first, elongate rigid member;
a second, elongate rigid member, each of the first, elongate rigid member and the second, elongate rigid member comprising:
an elongate channel along a length of the elongate rigid member defined by a U-shaped cross section of the respective elongate rigid member, the elongate channel configured to extend along and receive an upper railing of a shopping cart; and
a securing device mounted to the elongate rigid member and configured to secure the elongate, rigid member to the upper railing of the shopping cart when the elongate channel of the elongate rigid member receives the upper railing; and
a pair of flexible straps connecting opposing side walls of the first, elongate rigid member and the second, elongate rigid member at respective front connection locations and respective rear connection locations on the opposing sidewalls of the first, elongate rigid member and the second, elongate rigid member; and
wherein, the elongate, rigid members and the pair of flexible straps are connected to each other and arranged such that when the first and second elongate, rigid members are installed on opposite upper railings of the shopping cart and the securing devices secure the elongate rigid members to the opposite upper railings, the flexible straps are spaced to engage with and support the infant car seat on opposite, underside edges of the infant car seat.

20. The infant car seat supporting apparatus of claim 19, wherein each flexible strap of the pair of flexible straps comprises a tension mechanism configured to adjust a length of the respective flexible strap, and wherein the tension mechanisms of the flexible straps are adjustable such that the flexible straps are tensioned and extend substantially parallel between the first and second, elongate rigid members.
